(19) United States
(12) Patent Application Publication
(10) Pub. No.: US 2016/0148162 A1
(43) Pub. Date: May 26, 2016

(54) ELECTRONIC DEVICE AND METHOD FOR SEARCHING CALENDAR EVENT

(71) Applicant: FIH (HONG KONG) LIMITED, Kowloon (HK)

(72) Inventor: YI-CHANG DU, New Taipei (TW)

(21) Appl. No.: 14/579,834

(22) Filed: Dec. 22, 2014

(30) Foreign Application Priority Data
Nov. 25, 2014 (TW) 103140825

(51) Int. Cl. G06Q 10/10; G06Q 50/00

(52) U.S. Cl. CPC G06Q 10/1093; G06Q 50/01

(57) ABSTRACT

Method of searching a target calendar event using electronic device includes recording a calendar event when the calendar event is newly generated. A time period is set for searching target calendar events. One or more target calendar events is determined generated during the time period, and a date is determined corresponding to each of the one or more target calendar events. The time period is highlighted using a calendar view, and a preset icon is displayed in a data grid of each of the one or more determined dates of the calendar view.

### CROSS-REFERENCE TO RELATED APPLICATIONS

This application claims priority to Taiwanese Patent Application No. 103140825 filed on Nov. 25, 2014, the contents of which are incorporated by reference herein.

### FIELD

Embodiments of the present disclosure relate to searching technology, and particularly to an electronic device and a method for searching calendar events in the electronic device.

### BACKGROUND

An electronic device can be used to record calendar events. However, when large number of calendar events are recorded in the electronic device, it can be inefficient and inconvenient for a user to search for a particular calendar event from the electronic device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including a searching system.

FIG. 2 is a block diagram of function modules of the searching system included in the electronic device of FIG. 1.

FIG. 3 illustrates a flowchart of one embodiment of a method for searching target calendar events in the electronic device of FIG. 1.

FIG. 4 illustrates one example of a calendar view of the target calendar events.

FIG. 5 illustrates one example of the target calendar events.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

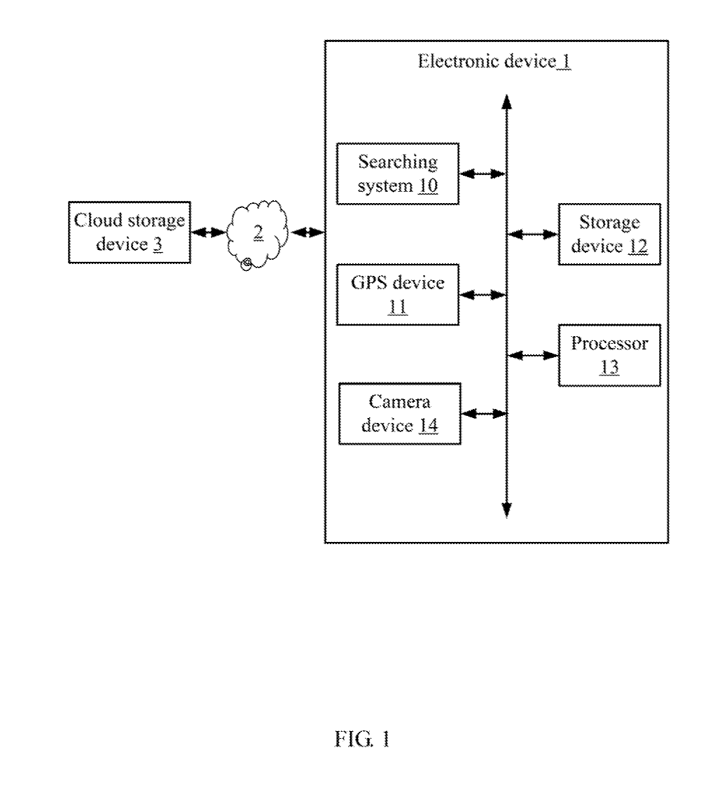

FIG. 1 is a block diagram of one embodiment of an electronic device in communication with a cloud storage device. Depending on the embodiment, an electronic device 1 is in communication with a cloud storage device 3 through a network 2. The electronic device 1 includes a searching system 10, a Global Positioning System (GPS) device 11, a storage device 12, and at least one processor 13. The electronic device 1 can be a smart phone, a personal digital assistant (PDA), a tablet computer, or any other suitable electronic device. FIG. 1 illustrates only one example of the electronic device 1 that can include more or fewer components than illustrated, or have a different configuration of the various components in other embodiments.

In one embodiment, the searching system 10 pre-stores calendar events in the cloud storage device 3, each of the calendar events records a captured image, a captured video, an article, a message and/or a comment posted in a preset social network (for example, the Facebook). The searching system 10 further searches one or more target calendar events from the cloud storage device 3 to find specified captured image(s), specified captured video(s), specified article(s), and/or specified comments.

The GPS device 11 detects position information of the electronic device 1. The storage device 12 can be an internal storage device, such as a flash memory, a random access memory (RAM) for temporary storage of information, and/or a read-only memory (ROM) for permanent storage of information. The storage device 12 can also be an external storage device, such as an external hard disk, a storage card, or a data storage medium.

In one embodiment, when the electronic device 1 captures images or videos using a camera device 14 of the electronic device 1, the electronic device 1 stores the captured images and videos in the storage device 12.

The at least one processor 13 can be a central processing unit (CPU), a microprocessor, or other data processor chip that performs functions of the electronic device 1.

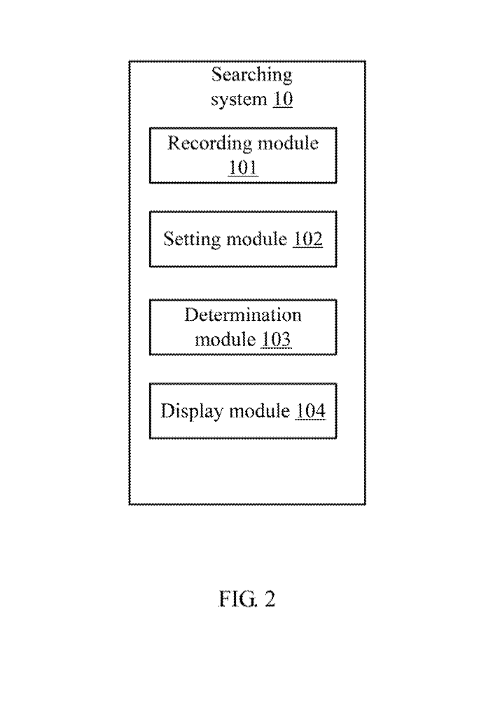

FIG. 2 is a block diagram of function modules of a searching system. In at least one embodiment, a searching system 10 can include a recording module 101, a setting module 102, a determination module 103, and a display module 104. The function modules 101-104 can include computerized codes in the form of one or more programs, which are stored in a storage device 12 of an electronic device 1, and are executed by at least one processor 13 of the electronic device 1 to provide functions of the present disclosure. Details will be given in the following paragraphs.

The recording module 101 records a calendar event when the calendar event is determined to be newly generated. In at least one embodiment, the calendar event records a captured image, a captured video, an article, a message and/or a comment posted in a preset social network (for example for example, the Facebook).

In one embodiment, the recording module 101 periodically (for example for example, at 1:00 am every day) detects whether any image or video is newly captured, according to captured date of the image and video. In one embodiment, the recording module 101 detects whether any image or video is newly captured by searching the storage device 12, which stores images and videos that are captured by a camera device 14 of the electronic device 1.

The recording module 101 obtains first related information of the image and video, when the image and video are determined to be newly captured.

In one embodiment, the first related information can include, but is not limited to, captured dates, captured positions, and exchangeable image file format (Exif) information of the image and the video. In one embodiment, the Exif information includes, but is not limited to, a model of the camera device 14 that captures the image and the video, an aperture size and a focal length of a lens of the camera device 14 when the camera device 14 captures the image and the video.

When the image and video are determined to be newly captured, the recording module 101 further stores the image and video, and the first related information of the captured image and video in a cloud storage device 3. The cloud storage device 3 is in communication with the electronic device 1 through a network 2.

In other embodiments, the recording module 101 further periodically (for example, at 1:00 am every day) detects whether any article, message or comment is newly posted in the preset social network, according to posted dates of the article, the message and the comment. In one embodiment, the recording module 101 detects whether any article, message or comment is newly posted in the preset social network by searching the preset social network using a preset user name and a password that are used to log in the preset social network.

When the article, the message and the comment are determined to be newly posted, the recording module 101 obtains second related information of the article, the message and the comment.

In one embodiment, the second related information can include, but is not limited to posted dates, posted positions, and posted websites of the article, the message, and the comment. The recording module 101 further stores the second related information in the cloud storage device 3.

The setting module 102 sets a time period for searching target calendar events in response to user input data. For example, the setting module 102 sets the time period to be a specified month, such as August in 2008. In one embodiment, the setting module 102 provides a setting interface for the user to set the time period.

The determination module 103 determines one or more target calendar events generated during the time period, and determines a date corresponding to each of the one or more target calendar events.

In one embodiment, the determination module 103 determines the one or more target calendar events by searching the first and the second information that are stored in the cloud storage device 3 according to the time period. If captured date in the first information and/or posted date in the second information are within the time period, the determination module 103 determines one or more calendar events corresponding to the captured date and/or the posted date.

For one example, when a first captured date of Aug. 2, 2014 is included in the first information, the determination module 103 determines a first target calendar event corresponding to the first captured date, because the first target calendar event is generated during the August in 2014. Similarly, when a second captured date of Aug. 16, 2014 is included in the first information, the determination module 103 determines a second target calendar event corresponding to the second captured date, because the second target calendar event is generated during August in 2014.

For another example, when a third posted date of Aug. 24, 2014 is included in the second information, the determination module 103 determines a third target calendar event corresponding to the third posted date, because the third target calendar event is generated during August in 2014.

The displaying module 104 highlights the time period using a calendar view. The displaying module 104 further displays a preset icon in a data grid of each of the one or more determined dates of the calendar view. In one embodiment, the preset icon is a thumbnail image of the captured image that corresponds to the data grid of the one or more determined dates.

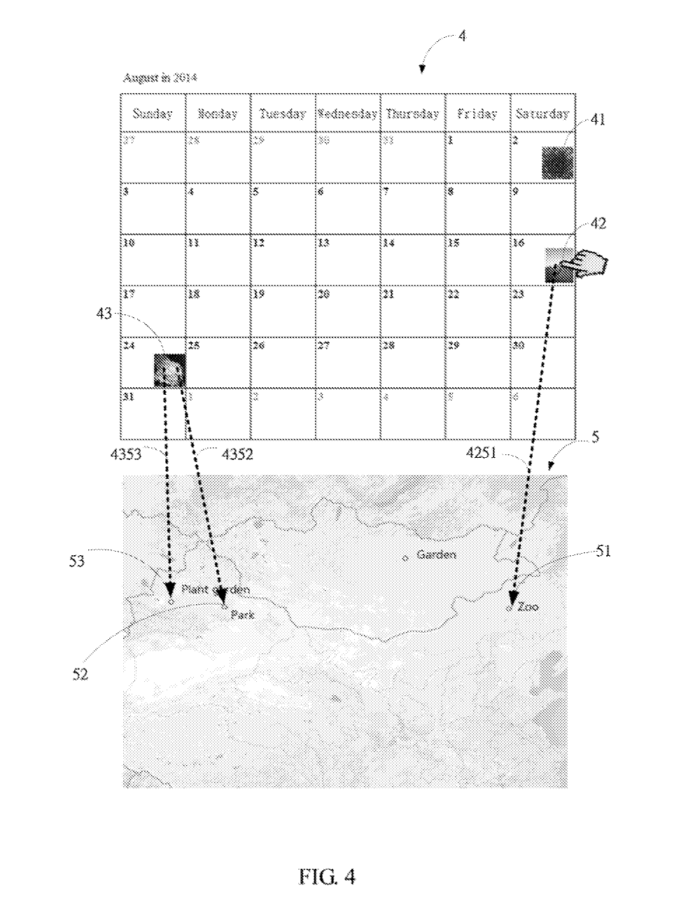

For example, as shown in FIG. 4, the displaying module 104 highlights August of 2014 using a calendar view 4. The displaying module 104 displays a first preset icon 41 in the data grid of Aug. 2, 2014 of the calendar view 4. The displaying module 104 displays a second preset icon 42 in the data grid of Aug. 16, 2014 of the calendar view 5. The displaying module 104 displays a third preset icon 43 in the data grid of Aug. 24, 2014 of the calendar view 4.

In one embodiment, the display module 104 further obtains a current position of the electronic device 1, using a Global Position System (GPS) device 11 of the electronic device 1. The display module 104 determines the current position to be a center of a map, and displays the map with the calendar view. As shown in FIG. 4, a map 5 can be displayed below the calendar view 4.

In one embodiment, the display module 104 further indicates an occurred position of each of the one or more target calendar events on the map when the occurred position is presented on the map.

For example, as shown in FIG. 4, the display module 104 displays the map 5 with the calendar view 4. If the second calendar event records one captured image, which is captured at a first position 51 of the map 5, the display module 104 indicates the first position 51 using a first indicating line 4251. The first indicating line 4251 connects the data grid of the captured date (for example, Aug. 16, 2014) of the one captured image and the first position 51.

For another example, it is assumed that the third calendar event records two captured images, a first captured image is captured at a second position 52 of the map 5, and a second image is captured at a third position 53 of the map 5. The display module 104 indicates the second position 52 using a second indicating line 4352, and indicates the third position 53 using a fourth indicating line 4353. The first indicating line 4351 connects the data grid of a captured date (for example, Aug. 24, 2014) of the first captured image and the second position 52. The third indicating line 4353 connects the data grid of a captured date (for example, Aug. 24, 2014) of the second capture image and the third position 53.

In one embodiment, the display module 104 further displays contents of each of the one or more target calendar events, when a corresponding touch signal on the target calendar event is received.

In one embodiment, when the target calendar event corresponding to the touch signal records one or more images and videos, the display module 104 obtains the one or more images and video from the cloud storage device 3, and displays the obtained images using an image album, and displays the obtained video using a video album on a display screen of the electronic device 1.

In other embodiments, when the target calendar event corresponding to the touch signal records one or more articles, messages, and comments, the display module 104 obtains the posted websites of the one or more articles, messages, and comments, from the cloud storage device 3. The display module 104 obtains web-pages including the one or more articles, messages, and comments from the websites through the network 2. The display module 104 further displays the obtained web-pages using a web-page album on the display screen of the electronic device 1.

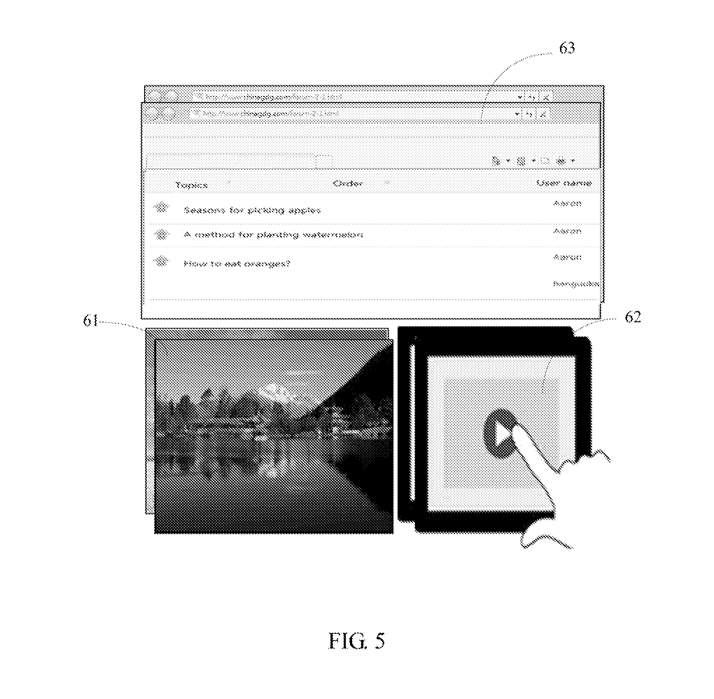

For example, as shown in FIG. 4, if the user touches the second preset icon 42, and the second calendar event records two captured images, two videos, and two articles. As shown in FIG. 5, the display module 104 displays the two captured images in an image album 61, displays the two videos in a video album 62, and displays the two articles in a webpage album 63.

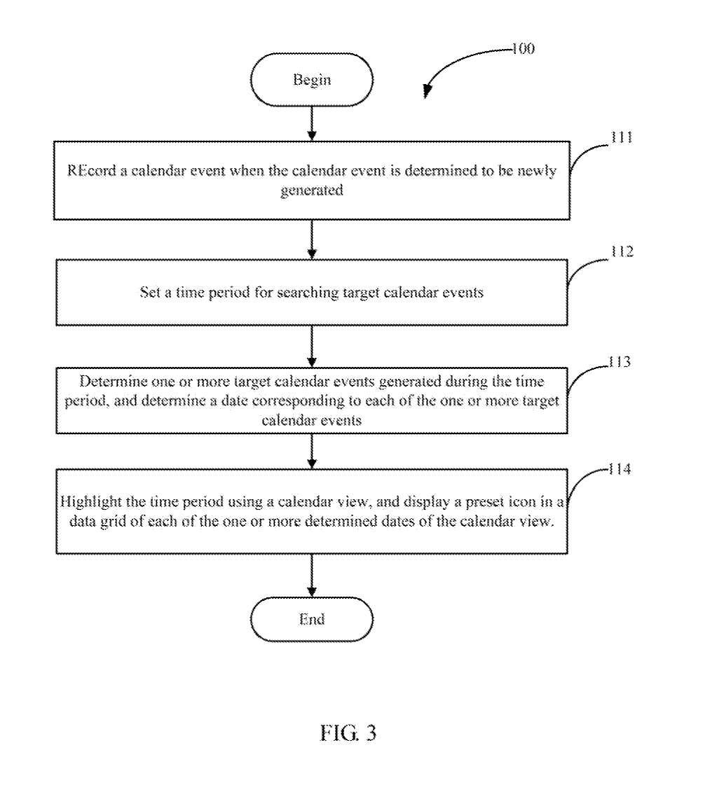

FIG. 3 illustrates a flowchart is presented in accordance with an example embodiment. The example method 100 is provided by way of example, as there are a variety of ways to carry out the method. The method 100 described below can be carried out using the configurations illustrated in FIG. 1, for example, and various elements of these figures are referenced in explaining example method 100. Each block shown in FIG. 2 represents one or more processes, methods or subroutines, carried out in the exemplary method 100. Additionally, the illustrated order of blocks is by example only and the order of the blocks can be changed according to the present disclosure. The exemplary method 100 can begin at block 111. Depending on the embodiment, additional steps can be added, others removed, and the ordering of the steps can be changed.

At block 111, an recording module records a calendar event when the calendar event is determined to be newly generated. In at least one embodiment, the calendar event records a captured image, a captured video, an article, a message and/or a comment posted in a preset social network (for example, the Facebook).

In one embodiment, the recording module periodically (for example, at 1:00 am every day) detects whether any image or video is newly captured, according to captured date of the image and video. In one embodiment, the recording module detects whether any image or video is newly captured by searching a storage device of an electronic device, which stores images and videos that are captured by a camera device of the electronic device.

The recording module obtains first related information of the image and video when the image and video are determined to be newly captured.

In one embodiment, the first related information can include, but is not limited to, captured dates, captured positions, and exchangeable image file format (Exif) information of the image and the video.

In one embodiment, the Exif information includes, but is not limited to, a model of the camera device that captures the image and the video, an aperture size and a focal length of a lens of the camera device when the camera device captures the image and the video.

When the image and video are determined to be newly captured, the recording module further stores the image and video, and the first related information of the captured image and video in a cloud storage device. The cloud storage device is in communication with the electronic device through a network.

In other embodiments, the recording module further periodically (for example, at 1:00 am every day) detects whether any article, message or comment has been newly posted on the preset social network, according to posted dates of the article, the message and the comment. In one embodiment, the recording module detects whether any article, message or comment has been newly posted in the preset social network, by searching the preset social network, using a preset user name and a password that are used to log in the preset social network.

The recording module obtains second related information of article, the message and the comment, when the article, the message and the comment are determined to be newly posted.

In one embodiment, the second related information can include, but is not limited to posted dates, posted positions, and posted websites of the article, the message, and the comment. The recording module further stores the second related information in the cloud storage device.

At block 112, a setting module sets a time period for searching target calendar events in response to user input data. For example, the setting module sets the time period to be a specified month, such as August in 2008. In one embodiment, the setting module provides a setting interface for the user to set the time period.

At block 113, a determination module determines one or more target calendar events generated during the time period, and determines a date corresponding to each of the one or more target calendar events.

In one embodiment, the determination module determines the one or more target calendar events by searching the first and the second information that are stored in the cloud storage device according to the time period. If a captured date in the first information and/or a posted date in the second information are within the time period, the determination module determines one or more calendar events corresponding to the captured date and/or the posted date.

For one example, when a first captured date of Aug. 2, 2014 is included in the first information, the determination module determines a first target calendar event corresponding to the first captured date, because the first target calendar event is generated during the August in 2014. Similarly, when a second captured date of Aug. 16, 2014 is included in the first information, the determination module determines a second target calendar event corresponding to the second captured date, because the second target calendar event is generated during the August in 2014.

For another example, when a third posted date of Aug. 24, 2014 is included in the second information, the determination module determines a third target calendar event corresponding to the third posted date, because the third target calendar event is generated during the August in 2014.

At block 114, a displaying module highlights the time period using a calendar view. The displaying module further displays a preset icon in a data grid of each of the one or more determined dates of the calendar view. In one embodiment, the preset icon is a thumbnail image of the image captured that corresponds to the data grid of the one or more determined dates.

For example, as shown in FIG. 4, the displaying module highlights August of 2014 using a calendar view. The displaying module displays a first preset icon in the data grid of Aug. 2, 2014 of the calendar view. The displaying module displays a second preset icon in the data grid of Aug. 16, 2014 of the calendar view. The displaying module displays a third preset icon in the data grid of Aug. 24, 2014 of the calendar view.

In one embodiment, the display module further obtains a current position, using a Global Position System (GPS) device of the electronic device. The display module determines the current position to be a center of a map, and displays the map with the calendar view. As shown in FIG. 4, a map can be displayed below the calendar view.

In one embodiment, the display module further indicates an occurred position (i.e., the captured position or the post position) of each of the one or more target calendar events on the map when the occurred position is presented on the map.

For example, as shown in FIG. 4, the display module displays the map with the calendar view. If the second calendar event records one captured image, which is captured at a first position of the map, the display module indicates the first position using a first indicating line. The first indicating line connects the data grid of the captured date (for example, Aug. 16, 2014) of the one captured image and the first position.

For another example, it is assumed that the third calendar event records two captured images, a first captured image is captured at a second position of the map, and a second image is captured at a third position of the map. The display module indicates the second position using a second indicating line, and indicates the third position using a third indicating line. The second indicating line connects the data grid of a captured date (for example, Aug. 24, 2014) of the first captured image and the second position 52. The third indicating line connects the data grid of a captured date (for example, Aug. 24, 2014) of the second capture image and the third position.

In one embodiment, the display module further displays contents of each of the one or more target calendar events, when a corresponding touch signal on the target calendar event is received.

In one embodiment, when the target calendar event corresponding to the touch signal records one or more images and videos, the display module obtains the one or more images and video from the cloud storage device, and displays the obtained images using an image album, and displays the obtained video using a video album on a display screen of the electronic device.

In other embodiments, when the target calendar event corresponding to the touch signal records one or more articles, messages, and comments, the display module obtains the posted websites of the one or more articles, messages, and comments, from the cloud storage device. The display module obtains web-pages including the one or more articles, messages, and comments from the posted websites through the network. The display module further displays the obtained web-pages using a web-page album on the display screen of the electronic device.

For example, as shown in FIG. 4, if the user touches the second preset icon, and the second calendar event records two captured images, two videos, and two articles. As shown in FIG. 5, the display module displays the two captured images using an image album, displays the two videos using a video album, and displays the two articles using a webpage album.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for searching a calendar event in an electronic device being executed by a processor of the electronic device, the method comprising:
recording a calendar event when the calendar event is determined to be newly generated;
setting a time period for searching target calendar events;
determining one or more target calendar events generated during the time period;
determining a date corresponding to each of the one or more target calendar events;
highlighting the time period using a calendar view; and
displaying a preset icon in a data grid of each of the one or more determined dates of the calendar view.

2. The method according to claim 1, further comprising:
displaying a map with the calendar view, a current position of the electronic device being determined to be a center of the map; and
indicating an occurred position of each of the one or more target calendar events on the map when the occurred position is presented on the map.

3. The method according to claim 1, wherein the calendar event records a captured image, a captured video, an article, a message and/or a comment posted in a preset social network.

4. The method according to claim 3, wherein the calendar event is recorded by:
periodically detecting whether any image or video is newly captured, and obtaining first related information of the image and the video when the image and video are determined to be newly captured;
periodically detecting whether any article, message or comment is newly posted in the preset social network, and obtaining second related information of the article, the message and the comment, when the article, the message and the comment are determined to be newly posted; and
storing the image, the video, the first related information of the image and the video, and the second related information in a cloud storage device that is in communication with the electronic device.

5. The method according to claim 4, wherein the first related information comprises captured date of the image and the video, captured position of the image and the video, and Exchangeable image file format (Exif) information of the image and the video, the second related information comprises posted date of the article, the message, and the comment, posted positions of the article, the message, and the comment, and posted websites of the article, the message, and the comment.

6. An electronic device comprising:
at least one processor; and
a storage device that stores one or more programs, when executed by the at least one processor, cause the at least one processor to:
record a calendar event when the calendar event is determined to be newly generated;
set a time period for searching target calendar events;
determine one or more target calendar events generated during the time period;
determine a date corresponding to each of the one or more target calendar events;
highlight the time period using a calendar view, and displaying a preset icon in a data grid of each of the one or more determined dates of the calendar view.

7. The electronic device according to claim 6, the processor further:
displaying a map with the calendar view, a current position of the electronic device being determined to be a center of the map; and
indicating an occurred position of each of the one or more target calendar events on the map when the occurred position is presented on the map.

8. The electronic device according to claim 6, wherein the calendar event records a captured image, a captured video, an article, a message and/or a comment posted in a preset social network.

9. The electronic device according to claim 8, wherein the calendar event is recorded by:
periodically detecting whether any image or video is newly captured, and obtaining first related information of the image and the video when the image and video are determined to be newly captured;
periodically detecting whether any article, message or comment is newly posted in the preset social network, and obtaining second related information of the article, the message and the comment, when the article, the message and the comment are determined to be newly posted; and
storing the image, the video, the first related information of the image and the video, and the second related information in a cloud storage device that is in communication with the electronic device.

10. The electronic device according to claim 9 wherein the first related information comprises captured date of the image and the video, captured position of the image and the video, and Exchangeable image file format (Exif) information of the image and the video, the second related information comprises posted date of the article, the message, and the comment, posted positions of the article, the message, and the comment, and posted websites of the article, the message, and the comment.

11. A non-transitory storage medium having stored thereon instructions that, when executed by a processor of an electronic device, causes the processor to perform a method for searching a target calendar event, wherein the method comprises:
recording a calendar event when the calendar event is determined to be newly generated;
setting a time period for searching target calendar events;
determining one or more target calendar events generated during the time period;
determining a date corresponding to each of the one or more target calendar events;
highlighting the time period using a calendar view, and displaying a preset icon in a data grid of each of the one or more determined dates of the calendar view.

12. The non-transitory storage medium according to claim 11, further comprising:
displaying a map with the calendar view, a current position of the electronic device being determined to be a center of the map; and
indicating an occurred position of each of the one or more target calendar events on the map when the occurred position is presented on the map.

13. The non-transitory storage medium according to claim 11, wherein the calendar event records a captured image, a captured video, an article, a message and/or a comment posted in a preset social network.

14. The non-transitory storage medium according to claim 13, wherein the calendar event is recorded by:
periodically detecting whether any image or video is newly captured, and obtaining first related information of the image and the video when the image and video are determined to be newly captured;
periodically detecting whether any article, message or comment is newly posted in the preset social network, and obtaining second related information of the article, the message and the comment, when the article, the message and the comment are determined to be newly posted; and
storing the image, the video, the first related information of the image and the video, and the second related information in a cloud storage device that is in communication with the electronic device.

15. The non-transitory storage medium according to claim 14, wherein the first related information comprises captured date of the image and the video, captured position of the image and the video, and Exchangeable image file format (Exif) information of the image and the video, the second related information comprises posted date of the article, the message, and the comment, posted positions of the article, the message, and the comment, and posted websites of the article, the message, and the comment.
